(19) United States
(12) Patent Application Publication
(10) Pub. No.: US 2006/0130027 A1
(43) Pub. Date: Jun. 15, 2006

(54) Data processing system and method

(76) Inventors: Gordon Douglas Hutchison, Eastleigh (GB); Rebecca Schaller, Cary, NC (US); Joseph Robert Winchester, Otterbourne (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/284,122

(22) Filed: Nov. 21, 2005

(30) Foreign Application Priority Data
Nov. 20, 2004 (GB) 0425581.6

(51) Int. Cl. G06F 9/45; G06F 9/44

(52) U.S. Cl. 717/141; 717/110

(57) ABSTRACT

A data processing method comprises receiving a user input, the user input corresponding to at least a portion of a programming language statement, displaying the portion of the programming language statement, detecting the requirement for a string component in the programming language statement portion, identifying the type of string component required in the programming language statement portion, and displaying string components of the identified type.

### BACKGROUND OF THE INVENTION

This invention relates to a data processing system and method, and to a computer program product for carrying out the data processing method.

In the field of computer programming, it is typical for a programmer to write a computer program using an editor or integrated development environment (IDE). The programmer enters lines of computer code using the editor or IDE. The programmer can also use the editor or IDE for completing and/or amending computer programs that have been previously created.

It is a known problem with all computer programming to produce a program that is free from errors. Such errors frequently occur through incorrect entry of lines of code by the original programmer. Any errors of spelling and/or syntax will usually result in the final compiled computer program operating less than fully accurately. Virtually all high level programming languages have a highly defined syntax for the terms and operations, which must be adhered to if the final program is to function properly. It is therefore desirous to produce editors and IDEs that can assist the programmer in reducing or eliminating errors during programming.

For example, U.S. Pat. No. 6,026,233 discloses a method and apparatus for presenting and selecting options to modify a programming language statement. This patent discloses an intelligent real time tool to assist a computer programmer during the writing and/or maintenance of a computer program. The tool generates assist windows that contain program related information that the programmer can use to construct a programming language statement and/or to obtain real time information about a programming language statement. An assist window can be automatically displayed as determined by the tool itself, and/or manually displayed on demand in response to a user input command. An assist window displays two general categories of information including, but not limited to, selection menu information based on a partial compilation of all programming language statements, and informational displays based on a partial compilation and a reverse parse of an immediate programming language statement. The statement generating tool assist windows are non-intrusive to programmer input and can be ignored by the programmer by merely continuing to type an immediate programming language statement without interacting with the assist windows that are proximate the programming language statement being constructed by the programmer.

This tool assists the programmer in two principal ways, firstly by displaying the syntax of any procedure call (also referred to as an argument) that the programmer is entering, and secondly by keeping track of the objects that have been created within the program and displaying possible objects that can correctly be used in specific parts of procedure calls. Code assist, or content completion, is becoming widely used when writing source code as it provides the programmer with a way of providing a list of suggested valid values, thereby reducing the likelihood of mistakes when the program is ultimately compiled. Code assist completion is based on prompting the user for information that can be derived from the language syntax and the semantics of the API being used.

In certain situations, a field or argument value that is to be entered comprises a string, where it is not actually a user visible object but, instead, contains parsable semantic information. The system described in the above patent does not offer any assistance to the programmer in this situation.

### SUMMARY OF THE INVENTION

According to a first aspect of the present invention, there is provided a data processing method comprising receiving a user input, the user input corresponding to at least a portion of a programming language statement, displaying the portion of the programming language statement, detecting the requirement for a string component in the programming language statement portion, identifying the type of string component required in the programming language statement portion, and displaying string components of the identified type.

According to a second aspect of the present invention, there is provided a data processing system comprising a user interface device for receiving a user input, the user input corresponding to at least a portion of a programming language statement, a display device for displaying the portion of the programming language statement, and a processor, the processor arranged to detect the requirement for a string component in the programming language statement portion, to identify the type of string component required in the programming language statement portion, and to control the display device to display string components of the identified type.

According to a third aspect of the present invention, there is provided a computer program product on a computer readable medium for controlling a data processing system, the computer program product comprising instructions for receiving a user input, the user input corresponding to at least a portion of a programming language statement, displaying the portion of the programming language statement, detecting the requirement for a string component in the programming language statement portion, identifying the type of string component required in the programming language statement portion, and displaying string components of the identified type.

Owing to the invention, it is possible to provide further assistance to a programmer who is writing a computer program. The data processing method and system will support the programmer as they are entering programming language statements. Those programming language statements that require input values as part of their format will be identified. The method and system will identify the type of value that is required and will provide the user with possibilities for completing the programming language statement from a list of appropriate possibilities.

Advantageously, the data processing method and system further comprises receiving a further user input, the further user input corresponding to a displayed component and inserting the selected displayed value component in the portion of the programming language statement. This aspect of the data processing method and system supports the programmer selecting from the displayed list of component values, and inserting the selected component in the programming language statement.

Preferably, the method and system further comprises receiving further user input, and manipulating the display of the displayed components according to the received input. In many circumstances, the number of possible component values that have been identified as suitable for use in the programming language statement will be very large, and it will not be possible to display all of the identified components on the display device at the same time. When this occurs, a shortening of the list will be necessary, with user controls for navigating to those component values that are not immediately visible.

Ideally, the step of identifying the type of string component value required in the programming language statement portion comprises accessing metadata relating to the programming language statement portion. In many high level languages there exists a series of metadata elements relating to each of the language statements of the programming language. By accessing the metadata element for the programming language statement that the programmer is currently entering, the data processing method and system can acquire information that it can utilise to populate the list of string components that are of the correct type for use in the current programming language statement. Without access to the contextual information about how the string component will be used the list of values cannot be restricted sufficiently. The metadata information is able to provide the scenario and usage context for the string which allows the completion values to be computed and narrowed down further.

### BRIEF DESCRIPTION OF THE DRAWINGS

Embodiments of the present invention will now be described, by way of example only, with reference to the accompanying drawings, in which:—

FIG. 1 is a schematic diagram of a data processing system;

FIG. 2 is a schematic diagram of a display device of the data processing system of FIG. 1; and

FIG. 3 is a flowchart of a data processing method.

### DESCRIPTION OF THE PREFERRED EMBODIMENTS

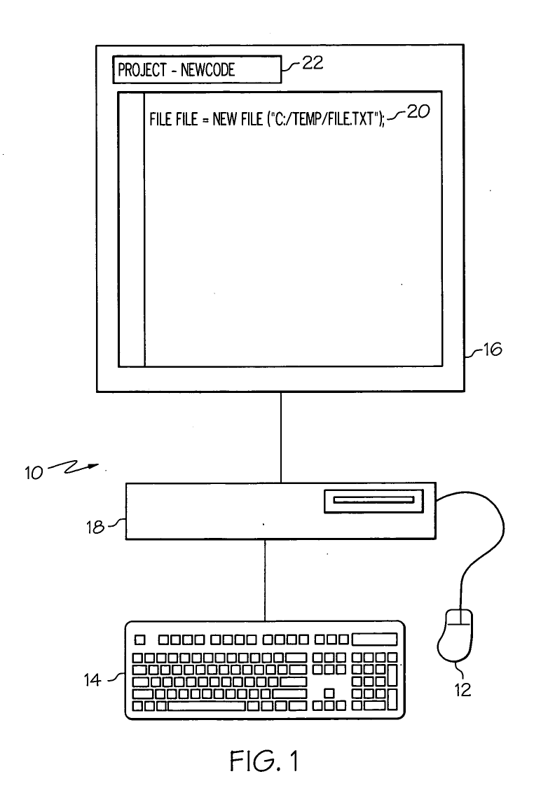

In FIG. 1, a data processing system 10 is shown, being a PC, with standard user interface devices, a mouse 12 and a keyboard 14. The data processing system 10 also includes a display device 16 and a processor 18. The processor 18 controls the display of the display device 16.

The processor 18 is running an application (a developer environment), in which a user can write a computer program for later compiling into an executable computer program. The programmer can use the application to begin writing a new computer program, or can amend or complete a program that has been created previously. Programs written in high level languages such as C and JAVA are typically created in this way.

The user interface devices 10 and 12 are for receiving the user input, the user input corresponding to at least a portion of a programming language statement 20. As the language statement is written by the programmer it appears on the display device 16, which is for displaying the portion of the programming language statement 20.

Programming language statements, which include instructions and operations, commonly refer to variables and objects. Any variable or object that is non-numerical or has a non-numerical component is referred to as a string. In the programming language statement 20 currently shown on the display device 16, the string component of the statement 20 is the portion “C:/temp/file.txt”. The computer programmer, in a known development environment will have to type this string in, without error, while maintaining the correction syntax of the component (which relates to the location of a file). This is a non-trivial task, and since the task will be repeated many times during the creation of the computer program, the likelihood of error is high.

In the data processing system of FIG. 1, the processor 18 is arranged to detect the requirement for a string component in any programming language statement portion 20 that the programmer is entering. This is achieved through knowledge of the syntax of each of the statements used in the programming language. Once the processor 18 is aware that a string component is required in the language statement portion 20, the processor 18 is arranged to identify the type of component value required in that programming language statement portion 20.

One group of string components can be regarded as parseable components, meaning that the string can be parsed (passed over by a parsing program) and logically broken up into its separate parts. In the example of FIG. 1, the string component of the programming language statement 20 constitutes the address of a file. This string component can be parsed to access information, including the logical drive location of the file “C” and also the path through that logical location “/temp” to the name of the file “file.txt”. Another example of a common parseable string is a URL (Uniform Resource Locator) which is used to address files and websites via the Internet. This string includes information about the resource and its information relating to its location that allows the resource to be accessed. Other parseable string types are discussed in more detail below.

Once the processor 18 has detected the requirement for a string component in the programming language statement portion 20 that the programmer is entering, the processor 18 is arranged to identify the type of string component that is required. Obviously in a simple example such as the “new File” command contained in the statement 20 shown in FIG. 1, it is a trivial task for the processor 18 to ascertain that a file name is required as the string component.

In general, to identify the type of string component, the processor 18 will access metadata relating to the language statement 20 being entered by the programmer to identify the type of string needed in the language statement 20. For a language such as JAVA, metadata is provided either by JavaBeans extensions (specification available at http://java.sun.com/products/javabeans/) or is provided, for example, by metadata that is part of Java 5 (http://jcp.org/aboutJava/communityprocess/review/jsr175/index.html/). Other resources are available for other programming languages. For example, Microsoft.net also provides a metadata facility through its com and activeX programming tools.

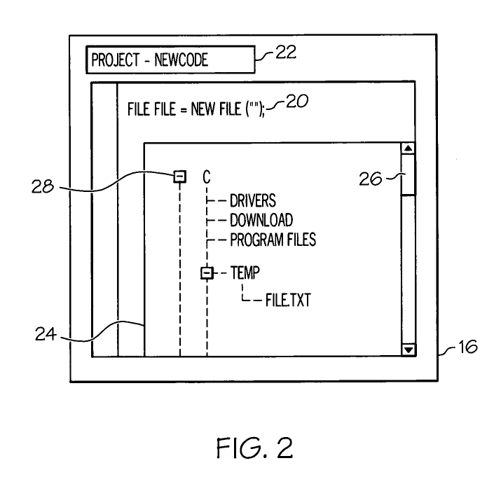

The processor 18, once it has identified the type of string component that is required in the language statement 20, will populate a list of possible candidates for the string component. The processor 18 is arranged to control the display device 16 to display string components of the identified type, in the form of a list. In effect, the processor 18 launches a new window 24, as can be seen in FIG. 2

This list will be organised depending upon the size of the identified potential candidates. If only a small number of possible candidates exist then these can be listed in a predetermined order on the display device 16. In reality, in the vast majority of situations a large number of possible strings will be able to be used as the string component of the language statement that the programmer is typing.

When this occurs, the processor 18 is arranged to provide only a portion of the available candidates on the display device 16, with the provision of tools to access the other, not shown, candidates. These tools will take the form of scroll bars (such as the scroll bar 26 in FIG. 2) or expansion buttons 28 on the display device 16, which let the programmer know that there are further potential candidates available.

The programmer can, via the user interface devices 12 and 14 take further action and the processor 18 will receive the user input, and manipulate the display of the displayed string components according to the received input. The programmer can manipulate the display in the new window 24, until they are able to see the element that they wish to use as the string component to complete the partial programming language statement 20.

The processor 18 is further arranged to receive a further user input, the further user input corresponding to a displayed string component. The programmer can select via, the mouse 12 and an on screen cursor, the string component that they wish to use and the processor 18 inserts the selected displayed string component in the portion of the programming language statement. The processor 18 then closes the assist window 24, and the programmer continues to input the lines of code into the editor.

Whenever the programmer enters a programming language statement that requires a string component, the processor 18 will launch the assist window 24 and give the programmer the choice of potential candidates for the string component to use to include in the statement that they are entering.

Further types of strings that are parseable, and so can be easily supported by the assist method described above include URLs (Uniform Resource Locators), named servers within a network domain, available printers within a network domain, database names discovered using a connection protocol such as JDBC or ODBC, and available web services at a given UDDI registry.

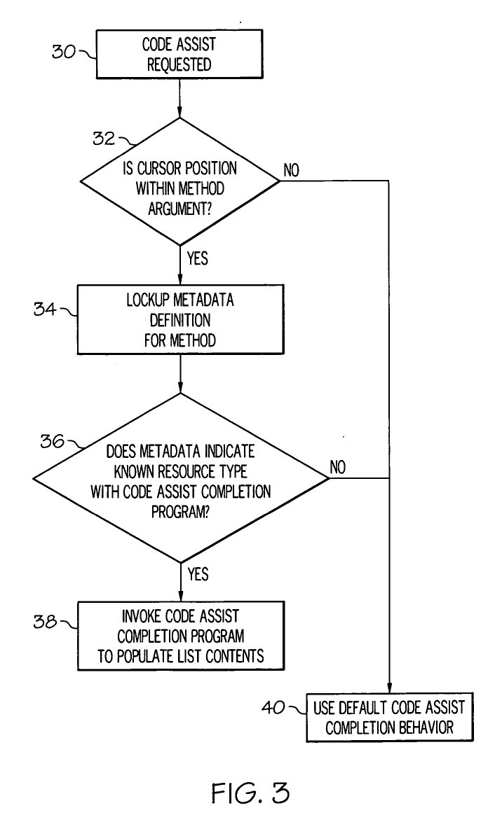

FIG. 3 illustrates the steps taken by the processor 18 when the programmer is entering a programming language statement. At step 30, the code assist is requested. This can be a direct request by the programmer, or the system can be configured that the assistance provided is requested automatically. At step 32, the position of the cursor on the display device is checked to see if the cursor is present in a programming language statement that is recognised by the processor 18. If not the routine will terminate the advanced assist and pass to stage 40, which will use standard default behaviour such as presenting a help message to the user.

The processor 18 will then move to step 34, at which point it will lookup the metadata definition for the current programming language statement, as described in more detail above. At step 36 the processor will extract, if possible, from the metadata the type of string (file name, or URL etc.) that is required in the language statement. If the processor fails in this task then again the method terminates at the stage 40. If however the string type can be identified, then the processor 18 moves to the final stage 38, and populates and displays the list of potential candidates.

1. A data processing method, comprising:
receiving a user input, the user input corresponding to at least a portion of a programming language statement;
displaying the portion of the programming language statement;
detecting a requirement for a string component in the programming language statement portion;
identifying the type of string component required in the programming language statement portion; and
displaying string components of the identified type.

2. A data processing method according to claim 1, further comprising
receiving a further user input, the further user input corresponding to a displayed string component; and
inserting the selected displayed string component in the portion of the programming language statement.

3. A data processing method according to claim 1, further comprising:
receiving further user input; and
manipulating the display of the displayed string components according to the received input.

4. A data processing method according to claim 2, further comprising:
receiving further user input; and
manipulating the display of the displayed string components according to the received input.

5. A data processing method according to claim 1, wherein the step of identifying the type of string component required in the programming language statement portion comprises accessing metadata relating to the programming language statement portion.

6. A data processing method according to claim 2, wherein the step of identifying the type of string component required in the programming language statement portion comprises accessing metadata relating to the programming language statement portion.

7. A data processing method according to claim 3, wherein the step of identifying the type of string component required in the programming language statement portion comprises accessing metadata relating to the programming language statement portion.

8. A data processing system, comprising:
a user interface device for receiving a user input, the user input corresponding to at least a portion of a programming language statement;
a display device for displaying the portion of the programming language statement; and
a processor, the processor arranged to detect the requirement for a string component in the programming language statement portion, to identify the type of string component required in the programming language statement portion, and to control the display device to display string components of the identified type.

9. A data processing system according to claim 8, wherein the processor is further arranged, in response to a further user input, the further user input corresponding to a displayed string component, to insert the selected displayed string component in the portion of the programming language statement.

10. A data processing system according to claim 8, wherein the processor is further arranged, in response to a further user input, to manipulate the display of the displayed string components according to the received input.

11. A data processing system according to claim 9, wherein the processor is further arranged, in response to a further user input, to manipulate the display of the displayed string components according to the received input.

12. A data processing system according to claim 8, wherein the step of identifying the type of string component required in the programming language statement portion comprises accessing metadata relating to the programming language statement portion.

13. A data processing system according to claim 9, wherein the step of identifying the type of string component required in the programming language statement portion comprises accessing metadata relating to the programming language statement portion.

14. A data processing system according to claim 10, wherein the step of identifying the type of string component required in the programming language statement portion comprises accessing metadata relating to the programming language statement portion.

15. A computer program product on a computer readable medium for controlling a data processing system, the computer program product comprising instructions for:
receiving a user input, the user input corresponding to at least a portion of a programming language statement;
displaying the portion of the programming language statement;
detecting the requirement for a string component in the programming language statement portion;
identifying the type of string component required in the programming language statement portion; and
displaying string components of the identified type.

16. A computer program product according to claim 15, further comprising instructions for:
receiving a further user input, the further user input corresponding to a displayed string component; and
inserting the selected displayed string component in the portion of the programming language statement.

17. A computer program product according to claim 15, further comprising instructions for:
receiving further user input; and
manipulating the display of the displayed string components according to the received input.

18. A computer program product according to claim 16, further comprising instructions for:
receiving further user input; and
manipulating the display of the displayed string components according to the received input.

19. A computer program product according to claim 15, wherein the step of identifying the type of string component required in the programming language statement portion comprises accessing metadata relating to the programming language statement portion.

20. A computer program product according to claim 16, wherein the step of identifying the type of string component required in the programming language statement portion comprises accessing metadata relating to the programming language statement portion.
